(19) United States
(12) Patent Application Publication
(10) Pub. No.: US 2017/0162056 A1
(43) Pub. Date: Jun. 8, 2017

(54) DETECTION OF AN OPEN AREA

(71) Applicant: Robert Bosch GmbH, Stuttgart (DE)

(72) Inventors: Achim Feyerabend, Heilbronn (DE); Alexander Thompson, Obersulm (DE); Christoph Schroeder, Sunnyvale, CA (US); Dominik Maucher, Stuttgart (DE); Oliver Pink, Stuttgart (DE)

(21) Appl. No.: 15/361,664

(22) Filed: Nov. 28, 2016

(30) Foreign Application Priority Data
Dec. 3, 2015 (DE) 102015224192.0

(51) Int. Cl. G08G 1/16; B60Q 9/00; G08G 1/01

(52) U.S. Cl. CPC G08G 1/166; G08G 1/0129; G08G 1/0112; B60Q 9/008

(57) ABSTRACT

A method for a vehicle equipped with a surroundings sensor system for generating an evaluation signal representing the trafficability of at least one route section to be traveled by the vehicle, the evaluation signal being ascertained as a function of surroundings data which are gathered with the aid of the surroundings sensor system, the evaluation signal being further ascertained as a function of at least one piece of surroundings information from an elevation map representing the topology of the at least one route section and/or at least one movement value of the vehicle representing a pitch and/or roll angle.

### CROSS REFERENCE

The present application claims the benefit under 35 U.S.C. §119 of German Patent Application No. DE 102015224192.0 filed on Dec. 3, 2015, which is expressly incorporated herein by reference in its entirety.

### FIELD

The present invention relates to a method, a device, and a computer program for evaluating the trafficability of route sections.

### BACKGROUND INFORMATION

A method for analyzing a route section to be traveled by a vehicle is described in German Patent Application No. DE 10 2011 081 614 A1. In this case, in one step, a determination of a hazard area in the route section to be traveled by the vehicle is carried out using image data which represent data transmitted by a vehicle-external unit and received via a vehicle interface.

A method is described in PCT Application No. WO 2014/074588, in which lane information is received regarding the present road on which a vehicle is situated. In addition, trajectories of further vehicles which travel the same route are identified and it is determined, on the basis of the received data and identified trajectories, whether the lane information has become unreliable. If the determination reveals that the lane information has become unreliable, a new trajectory is planned and the vehicle is steered along this trajectory.

In German Patent Application No. DE 10 2014 203 965 A1, methods and systems are described for carrying out lane or roadway determinations with respect to a road on which the vehicle is presently traveling. A determination is carried out with respect to a lane of a road on which a vehicle is presently traveling. An identification is carried out with respect to an adjacent lane which is adjacent to the lane in which the vehicle is presently traveling. The trafficability of the adjacent lane is ascertained.

### SUMMARY

The present invention provides a method for a vehicle equipped with a surroundings sensor system for generating an evaluation signal representing the trafficability of at least one route section to be traveled by the vehicle. The evaluation signal is ascertained depending on surroundings data which are gathered with the aid of the surroundings sensor system. In accordance with the method, the evaluation signal is also ascertained depending on
at least one piece of surroundings information from an elevation map representing the topology of the at least one route section
   and/or
at least one movement value of the vehicle representing a pitch and/or roll angle.

The method according to the present invention offers the advantage that an evaluation signal regarding the trafficability of at least one route section may be generated, which takes further important information into account regarding the surroundings or the vehicle in addition to the surroundings data recorded with the aid of the surroundings sensor system. As a result, a more reliable conclusion regarding the trafficability of the route section is possible. Surroundings data are understood to be all data which may be recorded with the aid of the surroundings sensor system. The surroundings sensor system may be made up of, for example, one or multiple cameras and/or a stereo-video camera and/or radar sensors and/or ultrasonic sensors and/or LIDAR and/or further common sensors utilized in the automotive industry.

In one embodiment variant of the present invention, a piece of surroundings information from an elevation map representing the topology of the at least one route section is taken into account, the piece of surroundings information containing elevation information. As a result, the trafficability of the route section may be represented even more reliably by the evaluation signal. In addition, the surroundings data may be linked to the surroundings information, whereby the reliability of the surroundings data may be checked. For example, the detection area of the sensors utilized may be evaluated with consideration for the road course/profile, in order to establish in which areas a measurement is possible and in which areas meaningful measured values/surroundings data cannot be delivered. In one alternative embodiment of the method according to the present invention, the surroundings data are linked to at least one movement value of the vehicle representing a pitch and/or roll angle. Due to the combination of the surroundings data and the at least one movement value, the detection area of the surroundings sensor system may be determined more precisely, whereby, in turn, a more reliable evaluation of the trafficability of the route section may be carried out. If the vehicle accelerates or decelerates, the vehicle undergoes a pitch movement, and when the vehicle travels through a curve, rolling movements may occur. Due to these movements, the visual field/the detection area of the surroundings sensors changes. This changed detection area may be evaluated, in order to establish in which areas a measurement is possible and in which areas the surroundings sensor system cannot deliver meaningful surroundings data.

According to the present invention, one specific embodiment of the method is also described, in which surroundings information regarding the topology of the at least one route section as well as at least one movement value representing a roll and/or pitch angle are incorporated into the generation of the evaluation signal. In this case, the use of the movement value additionally allows for a plausibility check of the surroundings information. In addition, with the aid of the combination of surroundings information and the movement value, the precise detection area of the surroundings sensor system may be determined and taken into account in the generation of the evaluation signal.

In one advantageous specific embodiment of the method, the at least one piece of surroundings information and/or the at least one movement value of the vehicle influences a detection area of the surroundings sensor system, from which the surroundings data are derived.

This specific embodiment offers the advantage that the additional surroundings information which is incorporated and/or the movement value may influence a detection area of the surroundings sensor system, whereby the surroundings data may therefore change or the surroundings data must be re-interpreted. If a piece of surroundings information reveals that a certain area, which was detected by the surroundings sensor system and was used for generating the evaluation signal, is unsuitable for a reliable evaluation of a route section, the surroundings data derived from the surroundings sensor system may change due to this additional information. If a camera, for example, detects no obstacles on an upcoming route section, the surroundings data derived therefrom could indicate a freely trafficable route section. However, if surroundings information is also available, which indicates that the upcoming route has a steep downhill grade which is not visible with the aid of a camera, this additional information may influence the surroundings data in such a way that these surroundings data no longer indicate a freely trafficable route section, but rather indicate that the surroundings data for certain areas do not allow for a meaningful evaluation/generation of an evaluation signal.

If the at least one movement value reveals that the vehicle is undergoing roll and/or pitch movements, this movement value may likewise result in the detection area of the surroundings sensor system and, therefore, the surroundings data derived therefrom, being influenced. For example, the detection area of a camera may change due to proper movements of the vehicle, so that different image areas are detected at different points in time. Due to the movement values being taken into account, individual image areas, for example, may be classified as impermissible for an evaluation of a route section, since these areas are detectable only in the event of certain pitch and/or rolling movements of the vehicle and cannot be continuously monitored. Due to the inclusion of the movement value, the surroundings data may therefore be adapted to the present driving situation.

In yet another specific embodiment of the method, the evaluation signal contains probability information regarding the trafficability of the route section.

Since multiple data and/or pieces of information and/or movement values are incorporated into the evaluation and these may include uncertainties with respect to the trafficability of the route section, it is advantageous to also use probability information or probability values for generating the evaluation signal. Due to the combination of the available data and/or information and/or movement values which have separate probabilities, if necessary, an overall probability value may also be determined, if necessary, which indicates a probability of the trafficability of the route section to be evaluated. Which data and/or information and/or movement values are provided with probabilities and which are not may vary depending on the application and/or driving situation and/or surroundings situation. The data and/or information and/or movement values being incorporated may be, for example, the surroundings data, surroundings information, movement values, information regarding further vehicles or the road course or any further possible input variables which are possible for an evaluation of the route section with respect to the trafficability, and/or which are mentioned in this description.

In yet another specific embodiment of the method, the evaluation signal is ascertained with the aid of the trajectory of a preceding vehicle.

This specific embodiment offers the advantage that the handling characteristics of preceding vehicles may be incorporated into the evaluation signal. Areas which possibly may not be detectable or may not yet be detectable with the aid of the vehicle's own surroundings sensor system may be evaluated on the basis of the behavior of preceding vehicles. The braking and/or acceleration behavior of the preceding vehicles may also be incorporated into the evaluation. In addition, it is possible that the driving trajectories of preceding vehicles are compared with map data and, in this way, possible conflicts between the planned trajectory and the actual trafficable trajectory may be established. Due to the continuous observation of a preceding vehicle, an area through which the preceding vehicle has traveled may be interpreted as an open area and, therefore, as a trafficable route section.

In yet another specific embodiment of the present invention, the evaluation signal is ascertained with the aid of road markings which were detected in an evaluation of the surroundings data.

This specific embodiment offers the advantage that a better evaluation of the trafficability of a route section is made possible on the basis of the road marking. On the one hand, the area between two road markings (street or roadway) may be assumed to be potentially trafficable, and the areas outside thereof may be assumed to be potentially not trafficable. On the other hand, the area up to a detected road marking—the detection taking place, for example, with the aid of a camera—is not hidden by a larger object in the normal case, and is therefore trafficable, since the road markings would not be detectable otherwise. Even when negotiating curves, advantages result in this way with respect to generating the evaluation signal regarding the trafficability of the route section.

In yet another advantageous specific embodiment of the present invention, the evaluation signal is ascertained with the aid of a digital road map, the map containing information regarding infrastructure features on the route section to be evaluated and/or regarding the road course of the route section to be evaluated.

This specific embodiment offers the advantage that the exact road course of the route section to be evaluated and possibly present infrastructure features are known. As a result, it may be already established in advance, if necessary, at which positions the detection area of the surroundings sensor system no longer includes the entire route section to be evaluated. Therefore, a corresponding evaluation of the trafficability of this route section or an evaluation of the reliability of the surroundings data may also be carried out in advance. In addition, the open area may be reduced in areas which cannot be detected directly by the surroundings sensor system, for example, gradients, blind curves, tunnels, underpasses, etc. Infrastructure features may be understood to mean any buildings, construction sites, and signs which may influence the traffic or the view of road users/of the surroundings sensor system, for example, tunnels, bridges, underpasses, soundproofing structures, hedges between lanes, construction site signage, and construction vehicles. If the vehicle approaches a blind curve, for example, this information may be incorporated into the evaluation and/or, if necessary, influence the surroundings data/the detection area of the surroundings sensor system. The information regarding a tunnel on the route section to be evaluated offers the possibility, for example, to define a clear lateral delimitation of the route section with respect to its trafficability. On the other hand, the changed visibility conditions may be taken into consideration when entering a tunnel, passing through the tunnel, or exiting the tunnel, whereby, if necessary, the surroundings data/the detection area may be influenced.

In yet another specific embodiment of the method, data and/or information and/or movement values which are incorporated into the evaluation signal are weighted to different extents.

This specific embodiment offers the advantage that, depending on the reliability of the data and/or information and/or movement values which are incorporated into the ascertainment of the evaluation signal, an adapted weighting of these data and/or this information and/or these movement values may be carried out. Data and/or information and/or movement values may be understood to be all properties, information, means and data which are incorporated into the evaluation. For example, the surroundings data, arbitrary signals from the surroundings sensor system, surroundings information, map data, topology data, information regarding preceding vehicles, road markings, visual fields, pitch and roll angles, movement values and further properties of the vehicle. Since not all data and/or information and/or movement values are equally reliable, the evaluation signal may be optimized with respect to the trafficability of a route section by carrying out an individual weighting.

In yet another specific embodiment of the method, the weighting of the data and/or information and/or movement values, which are incorporated into the evaluation, takes place as a function of an evaluation of the data and/or information and/or movement values.

This specific embodiment offers the advantage that, as a function of the gathered data and/or information and/or movement values, and due to a joint evaluation thereof, the reliability of the data and/or information and/or movement values may be assessed. If surroundings information, for example, is read in and suggests, due to a steep downhill grade or a steep uphill grade, that a route section may no longer be detectable with the aid of the surroundings sensor system, or if the surroundings sensor system could deliver data which could result in erroneous evaluations of the trafficability of the route section, the weighting of the surroundings data for ascertaining an evaluation signal from a certain route section may be reduced. Due to this specific embodiment, it is possible to weight the most meaningful data and/or information and/or movement values more strongly, depending on the situation, in order to allow an optimal evaluation signal for the route section to be ascertained on the basis of the data and/or information and/or movement values. Data and/or information and/or movement values which are classified as unreliable may therefore also be weighted to a lesser extent.

In one advantageous specific embodiment of the method, at least parts of the route section to be evaluated with respect to trafficability with the aid of the evaluation signal are not directly detectable by the surroundings sensor system.

This specific embodiment offers the great advantage that the route section to be evaluated does not necessarily need to be detectable by the surroundings sensor system. As a result, route sections may be specially evaluated, which may not be detectable or which may be detectable only in parts thereof by the surroundings sensor system. Due to the use of a preferably large amount of data and/or information and/or movement values along the route section to be evaluated, an evaluation of a route section which is not visible or is visible only in parts is made possible and therefore, the generation of an evaluation signal for this route section is made possible.

According to the present invention, a device is also described for generating an evaluation signal and for generating, depending on the evaluation signal, a warning signal and/or a prompt—which is dependent on the evaluation signal—to a driver to take over a driving task and/or for activating—depending on the evaluation signal—at least one actuator which intervenes in the driving dynamics of a vehicle. This device is characterized in that the evaluation signal is generated with the aid of the method according to the present invention.

This device makes it possible to generate an evaluation signal by carrying out the method according to the present invention. As a function of the evaluation signal, the device may generate a warning signal and/or a prompt to a driver to take over a driving task, in order to therefore warn a driver or further road users or to prompt a driver to take over the control of the vehicle. Advantageously, the driver may be notified early about a critical driving situation with the aid of this device and may react accordingly, for example, by reducing the speed of the vehicle before a blind curve or before a summit if a corresponding evaluation signal related to the route section is present, or if the trafficability cannot be ensured with a predefined probability. The probabilities that such a warning signal and/or a prompt for the driver to take over are/is output may be established specifically for a vehicle and/or a driver in this case.

Alternatively or additionally, the device may also activate an actuator based on the evaluation signal, whereby an intervention in the vehicle dynamics of the vehicle takes place. Therefore, the device may intervene in the vehicle dynamics of the vehicle in the event of an increased accident risk, in order to hereby avoid an accident or to reduce the probability of an accident. It is not imperative that the driver intervene in order for an actuator to be activated. Depending on the specific embodiment, a reduction of the speed, to a standstill, if necessary, a steering maneuver, or a further driving maneuver, for example, may be carried out as a result of the activation of corresponding actuators.

The device is also capable of generating evaluation signals for route sections which are not directly detectable by the surroundings sensor system. Safety measures may likewise be carried out on these route sections if, due to a corresponding evaluation signal of a route section, the risk of an accident must be considered to be increased.

Overall, this device therefore contributes to an increase in safety.

A computer program is also provided, which is configured for carrying out all steps of the method according to the present invention.

### BRIEF DESCRIPTION OF THE DRAWINGS

FIG. 1 shows two vehicles and one road having a steep downhill grade.

FIG. 2 shows two vehicles and one road having a steep uphill grade.

FIG. 3 shows two vehicles and one obstacle on a road.

FIG. 4 shows three vehicles, one vehicle being situated in a dip in the road.

FIG. 5 shows one exemplary method sequence.

FIG. 6 shows one exemplary method sequence.

### DETAILED DESCRIPTION OF EXAMPLE EMBODIMENTS

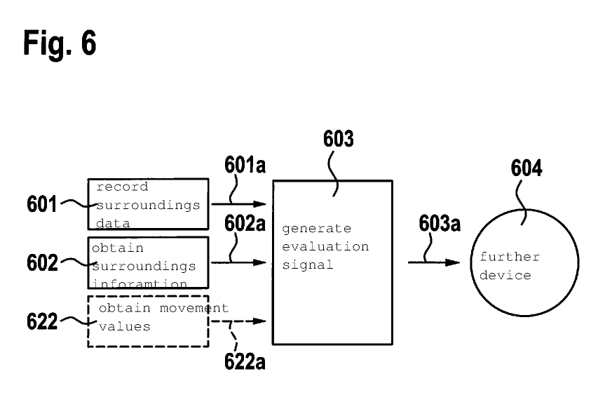

FIG. 6 shows one exemplary sequence of a method in in accordance with the present invention. In step 601, surroundings data 601a are recorded with the aid of the surroundings sensor system. In this example, a camera captures the area ahead of the vehicle.

In step 602, surroundings information 602a regarding the topology of the route section is obtained with the aid of a map which contains elevation information regarding the route section.

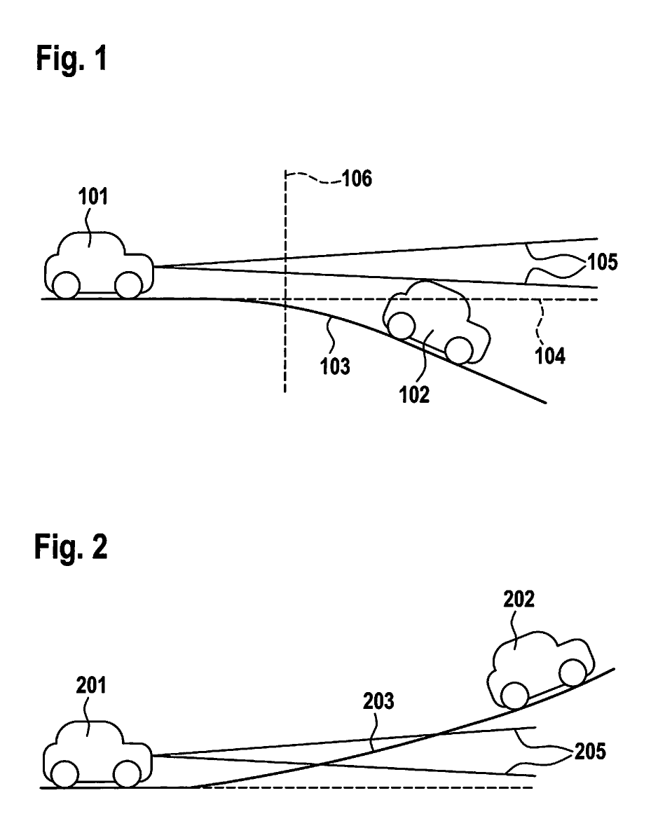

In step 603, surroundings data 601a and surroundings information 602a are utilized in order to generate an evaluation signal 603a of a route section with respect to the trafficability thereof. Surroundings information 602a is utilized in this case primarily in order to assess whether the route section to be evaluated is detectable/visible with the aid of the surroundings sensor system, i.e., the camera in this case. One exemplary situation is represented in FIG. 1, in which a preceding vehicle 102 has left detection area 105 of a forward looking sensor system of another vehicle 101 due to a downhill grade of road 103. If it is assumed that road 103 continues to be flat 104, the fact that vehicle 102 leaves detection area 105 could be interpreted by a driver assistance system of the other vehicle 101 to mean that the route ahead of the vehicle is freely trafficable and, suddenly, no other vehicle 102 is located there. With the aid of surroundings information 602a, the new method is capable of taking the downhill grade of road 103 into account during the ascertainment of evaluation signal 603a regarding the trafficability of the upcoming route section. As a result, it is not wrongly assumed that vehicle 102 has suddenly disappeared from the upcoming route section. Since preceding vehicle 102 is no longer detectable with the aid of the surroundings sensor system/forward looking sensor system due to the road topology, and a dangerous situation could possibly exist, the trafficability of the route is therefore evaluated more poorly than a route section which is completely detectable by the surroundings sensor system. The surroundings sensor system or the forward looking sensor system may be any common sensors and detection units, such as, for example, cameras, stereo-video cameras, radar, LIDAR, and/or ultrasonic sensors.

Instead of detecting topology information in step 602, movement values 622a representing the pitch and/or roll angle of the vehicle may be detected alternatively or additionally in step 622.

In step 603, these movement values 622a are linked to surroundings data 601a and an evaluation signal 603a representing the trafficability of the route section is ascertained. Due to the linkage, it is possible, for example, to reach more precise conclusions regarding the detection area of the surroundings sensor system and, therefore, to obtain more information from surroundings data 601a. If vehicle 201 from FIG. 2 accelerates, for example, the pitch angle of the vehicle may change, whereby detection area 205 temporarily changes and, overall, a larger area of the upcoming route section may be detected. In the event of a deceleration of vehicle 201, detection area 205 changes, likewise due to a change in the pitch angle. During negotiating a curve or any other type of variability of the vehicle, a change in the roll angle likewise results in a changed detection area 205. Due to a linkage of movement values 622a and the surroundings sensor system, surroundings data 601a recorded by the surroundings sensor system may be better interpreted and, therefore, better and more efficiently utilized.

In one embodiment variant of the present invention, in addition, only those detection areas 105, 205, 305, 405 may be evaluated, which remain detectable independently of the pitch or rolling movement/movement values 622a of vehicle 101, 201, 301, 401. Depending on the size of this angle, detection area 105, 205, 305, 405 is substantially reduced in this way. Simultaneously, it may be ensured, however, that this detection area 105, 205, 305, 405 is detectable by the surroundings sensor system for a longer period.

In one alternative embodiment, surroundings information 602a as well as movement values 622a may be used in step 603 for ascertaining evaluation signal 603a. In this case, movement values 622a may be used for a plausibility check of the road topology/the surroundings information. For example, it may be established on the basis of a movement value 622a representing a pitch angle whether vehicle 101, 201, 301, 401 is actually situated on a hillside having a downhill grade or an uphill grade. In addition, it is possible that, in the case of a upcoming downhill grade of road 103 and an impending dangerous situation, a vehicle 101, as is represented in FIG. 1, slightly enlarges detection area 105 by intentionally delaying and measuring movement value 622a representing a pitch angle, in order to possibly continue detecting preceding vehicle 102. The activation of the at least one actuator may therefore also be carried out in order to expand/enlarge detection area 105.

Evaluation signal 603a, after having been generated, may be forwarded and/or sent to an arbitrary further device 604. This device 604 may either already be a warning system and/or an actuator influencing the vehicle dynamics and/or an arbitrary control unit 604 which processes evaluation signal 603 and, based on evaluation signal 603a, activates a warning system and/or an actuator and/or a further control unit.

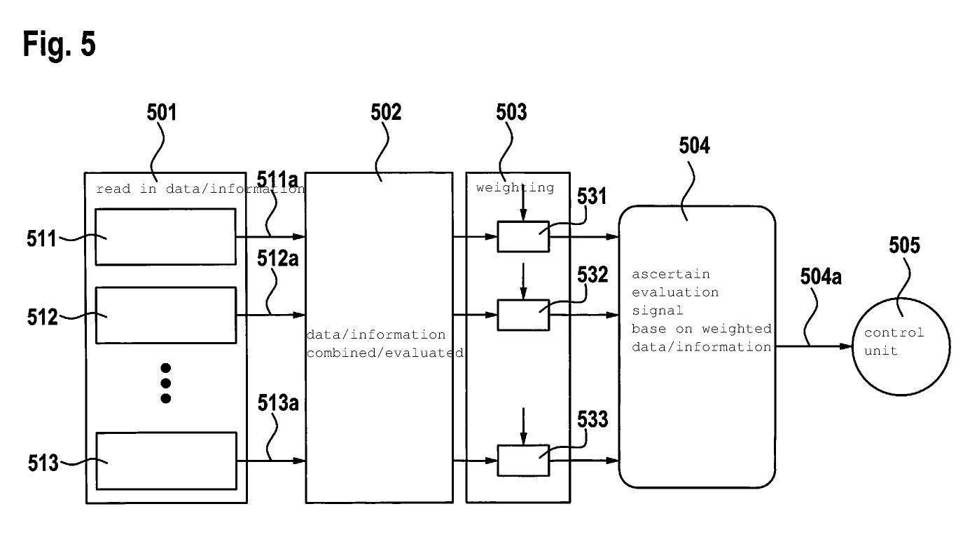

Yet another exemplary specific embodiment of the method is represented in FIG. 5. In step 501, a large amount of data and/or information 511a, 512a, 513a is read in 511, 512, 513. For example, surroundings data 511a, in particular camera images, surroundings information 512a regarding the topology of the route section, and movement values 513a representing pitch and/or roll angles may be read in.

In step 502, these data and/or this information 511a, 512a, 513a may be combined and data and/or information 511a, 512a, 513a may be evaluated on the basis of read-in data and/or information 511a, 512a, 513a. For example, it may be established, on the basis of surroundings information 602a regarding the route section to be evaluated, that a downhill grade or an uphill grade limits detection area 105, 205 of a surroundings sensor system, as shown in FIG. 1 or FIG. 2.

A weighting may then be carried out 531, 532, 533 in step 503 for all read-in data and/or information 511a, 512a, 513a, which reflects the reliability of data and/or information 511a, 512a, 513a in the present driving situation. The driving situation is analyzed and/or evaluated and/or ascertained in this case via the evaluation of data and/or information 511a, 512a, 513a in step 502.

In step 504, an evaluation signal 504a regarding the trafficability of the route section is ascertained on the basis of weighted data and/or information 511a, 512a, 513a. This evaluation signal 504a may be forwarded to a further control unit 604 or utilized for generating a warning signal or an activation of an actuator, in accordance with the method from FIG. 6.

In one specific embodiment of the method, the evaluation in step 502 may likewise result in some data and/or information 511a, 512a, 513a not being taken into account at all during the ascertainment of the evaluation signal regarding the trafficability of a special route section. If it is determined, for example with the aid of surroundings information 602a in the driving situation from FIG. 1, that a route section is no longer detectable with the aid of a forward looking video camera, due to a steep downhill grade, the associated camera data are therefore not incorporated into the evaluation of this route section at all. In this case, the camera data are utilized only for evaluating the route section which is reliably detectable (the route between vehicle 101 and the end of visual field 106). This procedure may be applied in a similar way to all further and previously mentioned sensor data and sensor types and is not limited to the camera data.

In one further exemplary embodiment, a vehicle 101, 201, 301, 401 equipped with a surroundings sensor system is equipped with a device according to the present invention. Different critical driving situations are described in the following, in which the method according to the present invention and the device according to the present invention are utilized.

In FIG. 1, a further vehicle 201 is situated ahead of vehicle 101. The further vehicle is traveling on a road 103 having a steep downhill grade. Since vehicle 102 could initially still be detected by the surroundings sensor system of vehicle 101, it is already outside of detection area 105 of the surroundings sensor system in FIG. 1. An evaluation signal 504a, 603a for the upcoming route section is generated with the aid of the method according to the present invention. On the basis of this evaluation signal 504a, 603a, a warning signal is generated in vehicle 201, which alerts the vehicle driver to the impending dangerous situation or uncertainty regarding the trafficability of the route.

If the vehicle is already highly automated and has the control of the vehicle at the point in time when the dangerous situation occurs, a warning signal may likewise be generated for a vehicle occupant, which prompts this occupant, for example, to take over the vehicle control.

Alternatively, vehicle 101 may also automatically adapt the speed to the new situation via an activation of a corresponding actuator. If the evaluation signal 504a, 603a compellingly indicates that an accident would occur with high probability, which is defined in the device, if an intervention were not carried out, the device in one exemplary embodiment is capable of automatically activating an actuator which brakes the vehicle, up to a standstill, if necessary.

In FIG. 2, situated ahead of vehicle 201 is a further vehicle 202 which has left detection area 205 of the surroundings sensor system due to the uphill grade of road 203. The surroundings sensor system, especially radar or LIDAR sensors, could wrongly interpret ascending road 203 as an obstacle. By taking surroundings information 602a into account, surroundings data 601a may be weighted correspondingly in this situation, whereby an adapted evaluation signal 504a, 603a for the route section may be generated.

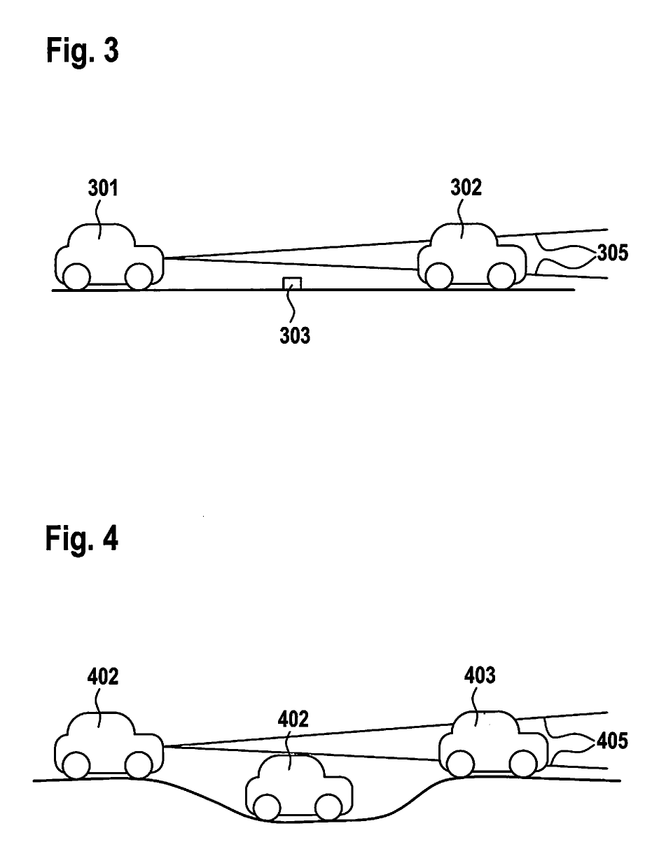

In FIG. 3, an obstacle 303 is situated between vehicle 301 and vehicle 302, which does not lie in detection area 305 of the surroundings sensor system of vehicle 301. In this exemplary embodiment, the trajectory of preceding vehicle 302 is recorded in addition to surroundings data 601a. Due to the evaluation of the different input variables or data and/or information 511a, 512a, 513a, the trajectory of preceding vehicle 302 was weighted very highly, since parts of the roadway could not be detected due to the driving situation. In this case, the device in vehicle 301 activates an actuator which controls vehicle 301 along the trajectory of vehicle 302, in order to thereby circumvent the obstacle. Areas not visible ahead of a preceding vehicle 302 may also be evaluated on the basis of the handling characteristics of preceding vehicle 302 and/or its trajectory.

In FIG. 4, vehicle 402 travels through a depression, whereby it leaves detection area 403 of the surroundings sensor system of vehicle 402. This surroundings sensor system detects vehicle 403 instead, which is traveling much further ahead. The area between vehicles 402 and 403 could be erroneously evaluated as trafficable in this situation. Due to the use of surroundings information 602a, the data from the surroundings sensor system may be correspondingly weighted in the ascertainment of evaluation signal 504a, 603a regarding the trafficability of the upcoming route section. With the aid of output evaluation signal 504a, 603a, a warning may be output to the driver or an activation of an actuator may be carried out, if necessary.

What is claimed is:

1. A method for a vehicle equipped with a surroundings sensor system for generating an evaluation signal representing the trafficability of at least one route section to be traveled by a vehicle, the method comprising:
ascertaining the evaluation signal as a function of surroundings data which are gathered with the aid of the surroundings sensor system;
wherein the evaluation signal is further ascertained depending on at least one of: i) at least one piece of surroundings information from an elevation map representing the topology of the at least one route section, and ii) at least one movement value of the vehicle representing at least one of a pitch and a roll angle.

2. The method as recited in claim 1, wherein the at least one piece of the surroundings information and the movement value of the vehicle influences a detection area of the surroundings sensor system, from which the surroundings data are derived.

3. The method as recited in claim 1, wherein the evaluation signal contains probability information regarding the trafficability of the route section.

4. The method as recited in claim 1, wherein the evaluation signal is ascertained with the aid of a trajectory of a preceding vehicle.

5. The method as recited in claim 1, wherein the evaluation signal is ascertained with the aid of roadway markings which were detected during an evaluation of the surroundings data.

6. The method as recited in claim 1, wherein the evaluation signal is ascertained with the aid of a digital road map, the map containing information at least one of: i) regarding infrastructure features on the route section to be evaluated, and ii) regarding a road course of the route section to be evaluated.

7. The method as recited in claim 1, where at least one of the surroundings data, the surroundings information and the movement values which are incorporated into the evaluation signal are weighted to different extents.

8. The method as recited in claim 7, wherein the weighting takes place as a function of an evaluation of at least one of the surroundings data, surroundings information, and movement values.

9. The method as recited in claim 1, wherein at least parts of the route section to be evaluated with respect to trafficability with the aid of the evaluation signal are not directly detectable by the surroundings sensor system.

10. A device for a vehicle equipped with a surroundings sensor system, the device designed to:
ascertain an evaluation signal as a function of surroundings data which are gathered with the aid of th surroundings sensor system, the evaluation signal representing the trafficability of at least one route section to be traveled by the vehicle, wherein the evaluation signal is further ascertained depending on at least one of: i) at least one piece of surroundings information from an elevation map representing the topology of the at least one route section, and ii) at least one movement value of the vehicle representing at least one of a pitch and a roll angle;
at least one of: i) generate, depending on the evaluation signal, at least one of a warning signal and a prompt, to a driver to take over a driving task of the vehicle, and ii) activate depending on the evaluation signal at least one actuator which intervenes in the driving dynamics of the vehicle.

11. A non-transitory machine-readable storage medium on which is stored a computer program for a vehicle equipped with a surroundings sensor system for generating an evaluation signal representing the trafficability of at least one route section to be traveled by a vehicle, the computer program, when executed by a processor, causing the processor to perform:
ascertaining the evaluation signal as a function of surroundings data which are gathered with the aid of the surroundings sensor system;
wherein the evaluation signal is further ascertained depending on at least one of: i) at least one piece of surroundings information from an elevation map representing the topology of the at least one route section, and ii) at least one movement value of the vehicle representing at least one of a pitch and a roll angle.
